(19) United States
(12) Patent Application Publication
(10) Pub. No.: US 2013/0144950 A1
(43) Pub. Date: Jun. 6, 2013

(54) Seamless collaboration and communication

(71) Applicants: Manikandan Sanakaranarasimhan, Folsom, CA (US); Radhakrishnan Kupathil, Palo Alto, CA (US); Ankush Tiwari, Pune (IN)

(72) Inventors: Manikandan Sanakaranarasimhan, Folsom, CA (US); Radhakrishnan Kupathil, Palo Alto, CA (US); Ankush Tiwari, Pune (IN)

(21) Appl. No.: 13/592,909

(22) Filed: Aug. 23, 2012

Related U.S. Application Data
(60) Provisional application No. 61/567,519, filed on Dec. 6, 2011.

(51) Int. Cl. G06F 15/16

(52) U.S. Cl. 709/204

(57) ABSTRACT

The embodiments herein relate to user interaction and, more particularly, to enabling collaboration and communication in a seamless manner between multiple users. Once the user select the content to be collaborated using a user device, the system provides the user a list of available collaboration modes for the user to start collaboration. Further the user selects atleast one user to start collaboration with. Further the system selects atleast one best communication mode for each user to communicate. The system uses parameters such as augmented ubiquity, to identify best communication mode for each user. Further the system starts collaboration and communication session. The system may automatically begin the collaboration session at a preset time. The system facilitates collaboration and communication together in a seamless manner.

This application claims the benefit of U.S. Provisional Application No. 61/567,519, filed 6 Dec., 2011.

### TECHNICAL FIELD

The embodiments herein relate to user interaction and, more particularly, to enabling collaboration and communication in a seamless manner between multiple users.

### BACKGROUND

Collaboration is the process of working together by a set of entities or people to achieve a common goal. Communication is the process of exchanging information between a set of people.

Proliferation of communication technologies has enabled users to collaborate and communicate on documents between a distributed set of people. Convergence of technologies has also made possible for people to collaborate and communicate at the same time. However, currently, there are multiple disjoint technologies available for doing collaboration, but the disjoint technologies are not working together to provide seamless experience to end users, with the end users having to use multiple applications simultaneously and multiple communication modes to enable collaboration.

Today, users need to pick up a mode of collaboration and then decide the communication mode. Also, this process is not automated. Consider an example where multiple collaboration mechanisms such as cloud, email etc. are used for content sharing. Then the method of communication needs to be chosen separately. So, at the time of usage, the end user needs to use multiple applications and multiple communication modes for collaboration. There is a need for the user to remember, store various contact information and separately invoke different application (like calendar, chat messenger, call etc.) for achieving simple use cases. Due to disjoint nature of the apps involved to achieve simple use cases for collaboration and communication it's very tedious for a user to achieve collaboration. Overall this is a very disjoint experience for an end user.

### BRIEF DESCRIPTION OF THE FIGURES

The embodiments herein will be better understood from the following detailed description with reference to the drawings, in which:

FIG. 1 depicts a communication network connecting devices used by various users that may participate in a seamless collaboration and communication session, according to embodiments herein;

FIG. 2 depicts a block diagram of a user device that supports seamless collaboration and communication, according to embodiments herein;

FIG. 3 shows a screenshot of a collaboration landing page, according to an example embodiment;

FIG. 4 is a flow diagram illustrating the process of initiating a seamless collaboration and communication session, according to embodiments herein;

FIG. 5 is a flow diagram illustrating the process of using augmented ubiquity data to facilitate one click collaboration for a group of participants, as disclosed in the embodiments herein;

FIG. 6 shows a screenshot of an exemplary implementation, where the instant application integrates with Microsoft SharePoint to provide collaboration support, according to an example embodiment;

FIGS. 7, 8, 9 and 10 show screenshots depicting a user selecting a content for collaboration, the time of review (instant review as depicted herein), selecting the communication mode and the user selecting users from the users present online for instant review respectively, according to an example embodiment; and

FIG. 11 shows a screenshot depicting a document being viewed and collaborated on and an associated chat window, according to an example embodiment.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

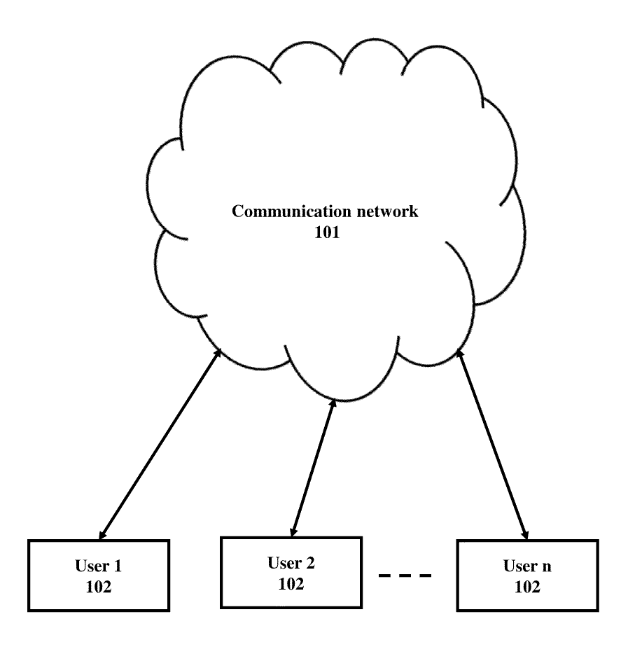

The embodiments herein disclose a method and system for enabling collaboration and communication seamlessly. Referring now to the drawings, and more particularly to FIGS. 1 through 10, where similar reference characters denote corresponding features consistently throughout the figures, there are shown embodiments.

Collaboration is defined as any means of sharing content (documents, files, content) over internet, mail, cloud or any other means in which content can be transferred between multiple users. Collaboration can be for the purposes of sharing information, review etc. The collaboration may be achieved using multiple tools like wiki, SharePoint, Village etc.

Communication is defined as any mode of communication including but not limited to audio call, video call, VOIP calls, chat, desktop sharing, whiteboard sharing etc.

FIG. 1 depicts network architecture for a seamless collaboration and communication session, according to embodiments herein. The architecture comprises communication network 101 and plurality of user devices 102. The communication networks 101 may be one or a combination of networks including but not limited to Internet, a cellular communication network, and a Public switched telephone network (PSTN) based communication network. The user devices 102 comprise of any device which is capable of communicating with communication network 101. Further, the user device 102 may comprise of phones, Personal Digital Assistants (PDAs), tablets, laptops, computers or any other device that supports a standard operating system like Android, Microsoft Windows, Linux, Symbian, iOS and so on and that can connect to communication network 101.

The user devices 102 enable the users of the devices 102 to participate in a seamless collaboration and communication session. A user may select content for collaboration using his user device 102. The content may be a document, a presentation, a video, an audio file, an image file or any content which may be capable of being edited by a user. The content selected is dependent on the capability of the underlying user device 102 to associate and launch an appropriate application for the content that integrates with the instant application.

Once the user has selected the document for collaboration, the user chooses a mode for collaboration. In one embodiment, the user may be provided with a list of available collaboration modes. Further, the user can select a particular collaboration mode from the available collaboration modes. The system may facilitate collaboration using applications such as AceProject, Collaba and so on. Further, the collaboration application provided to the user may be set up on the cloud or may be hosted on corresponding server. For example, the when a user begins collaboration on a content using a suitable collaboration application, the system may upload the content to the corresponding server or to a cloud. Further the system may send a link of the location in server or cloud where the content has been saved, to the users who are part of collaboration. Further the users can access the document using the link. In another example, at least two users can perform real-time collaboration using desktop sharing. By virtue of desktop sharing feature, one user can share his/her desktop with the other users.

Further, the user selects a set of other users with whom the collaboration and communication would happen. The users may be selected from a list of contacts (a phonebook, a contact list, a friends list and so on). The user may also enter their respective contact details manually. The user can enter new contacts to the contact list and may also be able to remove and/ block certain contacts. In one embodiment, the user may enter the new contacts to the contact list manually. In another embodiment, the system may provide means for automatically adding new contacts to the contact list. For example, the system may request access to online contact lists of user (For example, user's contact list in social networking sites such as facebook, twitter and mail accounts such as GMAIL, YMAIL and so on) and may automatically add the contacts to user's contact list. The system may also provide means for grouping contacts to avoid duplication. For example, User B may be present in both GMAIL and FACEBOOK contact lists of User A. The system may provide options to merge and save both accounts of User B under a single name in User A's contact list. The selected contact details may reflect the mode, in which the users want to communicate.

Further, the system selects best communication modes to initiate collaboration and communication with the selected users. The communication mode (s) selected by the system may be at least one of online chat, audio call (over the internet or a phone network (cellular/PSTN)), video call (using the internet, phone network (cellular/PSTN), a combination of internet and phone networks), using desktop share and call or real time review and so on. The system may also select a combination of modes, depending on the convenience of the users involved in the collaboration. In one embodiment, the communication mode (s) selected by the system to facilitate communication between the selected users may be best communication modes.

In one embodiment, the system may identify the best communication mode for a user considering augmented ubiquity data related to that particular user. The system may consider various parameters related to users such as location of the user, communication preference of the user, status of the user and so on in order to form augmented ubiquity data related to each user. Further the system may select a best communication mode for the user to communicate, considering the augmented ubiquity data.

In another embodiment, the system may also provide means for the user who initiates collaboration to select preferred communication mode manually if the augmented ubiquity data is not available. In this case, the system may provide a list of available communication modes to the user and the user may manually select a suitable communication mode from the list.

In another embodiment, the system may be capable of automatically initiating communication for collaboration on a preset time period without user intervention, with time for initiating collaboration and communication being preset by the user who initiates the user interaction session. In another embodiment, the communication and the collaboration may be provided to the user as a single application.

Further, the system presents the user with a User Interface (UI) comprising of the selected users and the respective communication modes. The UI enables the user to initiate and/or send the collaboration message to the other users, along with an approved time slot for the collaboration. The collaboration message may be in the form of a text message, audio message and so on. Further, the collaboration message may be sent to the user device in the form of a text message, voice message and so on. In one embodiment, the UI may provide means for initiating collaboration and communication by clicking/pressing a collaboration icon/switch using the user device 102. In another embodiment, the collaboration and communication session may be initiated for the same time. In another embodiment, the collaboration session may be initiated for a later time. Once the collaboration is under process, the users may access the document, which may be opened automatically at the specified time of collaboration. There may also be an interaction window opened, where the interaction window depends on the selected communication mode. For example, if the selected communication mode is text chat mode, a window may appear in which the user can text his/her questions and comments.

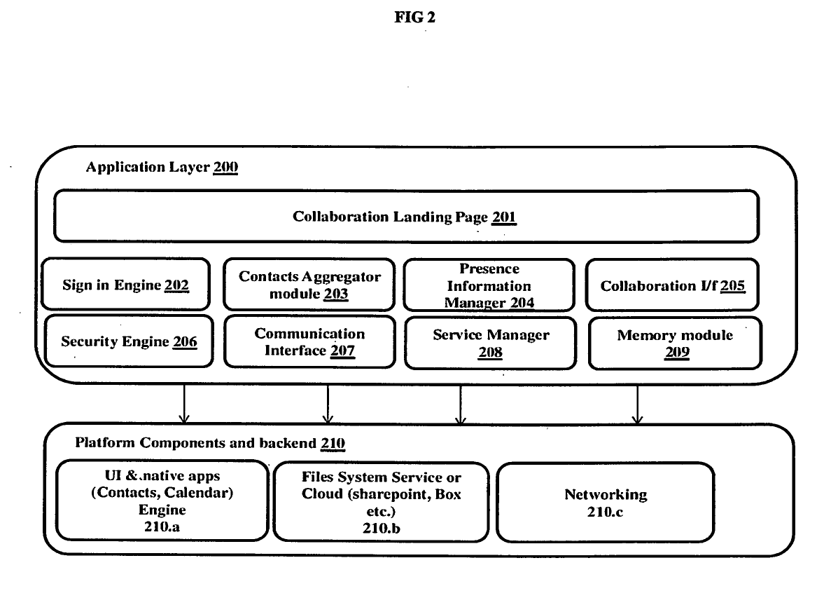

FIG. 2 depicts a block diagram of a user device that supports seamless collaboration and communication, according to embodiments herein. The user device, as depicted comprises of an application layer 210, and platform components and backend layer 209. In at least one embodiment, the application layer 210 comprises a collaboration landing page 201, a sign in engine 202, a contact aggregator module 203, a presence information manager 204, a collaboration interface 205, a security engine 206, a communication interface 207, a service manager 208, memory module 209 and platforms component and backend 209.

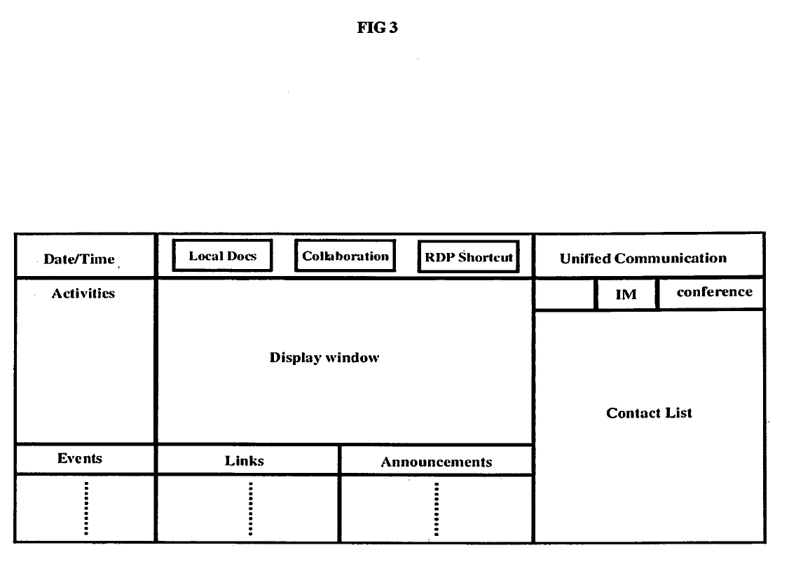

The collaboration landing page 201 (depicted as an example embodiment in FIG. 3) is the landing page, when the user invokes the application, which may be either for setting up the collaboration or for attending collaboration. Further, the landing page as shown in FIG. 3 may comprise user interface (UI) options using which the user can invoke various applications such as collaboration applications, communication applications and so on. The user may be able to view information on recent activities such as recently contacted users, type of communication mode used, time period of communication and so on, in the activity window. The event window may show various upcoming events such as a pre-scheduled collaboration sessions, scheduled time and so on. The user may also be provided with links to the content being shared, in the links window.

On top of the screen, the user is provided with options such as local docs, collaboration, RDP shortcuts. The local docs option may help the user to select documents which are present in the local device i.e. user device. The collaboration option may help the user to enter into a collaboration mode. The RDP shortcut may help the user to view screen of another device through a remote desktop sharing mechanism.

The unified communication window provides list of contacts available in the contact list of the user. The window also provides available communication modes such as Instant Messaging (IM), conference and so on to the user. Further, the user can use the display window to view collaborated contents and/or for viewing other users or desktops while video conferencing option/desktop sharing option is selected. The landing page may act as an interface between the system and the user. Further, the user can select specific options from the landing page using a suitable hardware user interface. The hardware user interface may be a touch screen, keyboard mechanism, gesture recognition mechanism and so on.

The sign in engine 202 enables the user to login to the collaboration tool and all applications related to collaboration from a single point. Further, the user can enter his/her sign in information using a suitable user interface (UI) such as a keyboard, touch screen and so on. Further, the sign in engine 202 may compare the login information received from the user with a pre-stored database of user login information to validate the user login information. The database which comprises login information corresponding to each user may be present in the memory module 209.

The contact aggregator module 203 enables the user to access all the information of his contacts from a single location. The contacts may be aggregated from multiple sources such as an email contact list, a phone book and so on. Further, the contacts aggregated from multiple sources may be presented to the user in order to select a person or a plurality of people to initiate collaboration and communication with The presence information manager 204 detects the presence of contacts of the user online using a suitable means. The presence information manager 204 may receive the list of contacts from the contact aggregator module 203. Contacts may be present online in a manner accessible to the user, such as a chat engine, the collaboration tool and so on.

The collaboration interface 205 serves as an interface between the collaboration tool and the various applications, which are required for collaborating on the selected content. The application may be present locally on the user device 102 or on a cloud, which is accessible to the user device 102.

The security engine 206 provides a secure operating environment to the user device 102. The security engine 206 prevents unauthorized access to the contents being accessed by the collaboration tool. The security engine 206 may also provide means for detecting malware contents that may be sent over the collaboration network. The security engine 206 may scan the links and contents transmitted over the collaboration network so as to detect affected contents.

The communication interface 207 enables the user of the user device 102 to communicate with other users. The communication interface 207 may provide implementation for a plurality of communication methodologies including but not limited to Representational state transfer (REST) interface, Session Initiation Protocol (SIP) interface or any other suitable protocol for interaction with other users.

The service manager 208 manages services auxiliary to the collaboration tool including but not limited to printers, scanners and so on.

The memory module 209 may comprise at least one database or a plurality of databases that may further comprise data such as user login information required for the sign in engine 202, user contact information required for the contact aggregator module 203, presence information of user contacts gathered by the presence information manager 204 and so on which is later used for the collaboration and communication purpose.

The platforms component and backend 210 comprises of a UI and native applications 210.a (such as contacts, calendar, memos and so on), a file system service 210.b (such as MS SharePoint, Box and so on), cloud and networking interfaces 210.c.

The application layer uses the capabilities of the underlying platform components 210 and applications to deliver content for collaboration and enable communication.

In some embodiments, the application layer 200 may be hosted within another application in the underlying platform 210 as a plug-in to deliver the integrated capabilities of integrated collaboration and communication.

In some embodiments, the application layer 200 may be an independent application that runs stand alone on the platform with capabilities to invoke external applications (for example, applications like MICROSOFT SHAREPOINT or WORD document processors and so on) for collaboration.

In some embodiments, the application layer 200 may host specific application modules internally that may render and enable functions on specific content (ex: text, voice, xml, multimedia etc) for collaboration. In such cases, the application layer may use the capabilities of such application modules to enable collaboration rather than an external application; for example, applications like MICROSOFT SHAREPOINT.

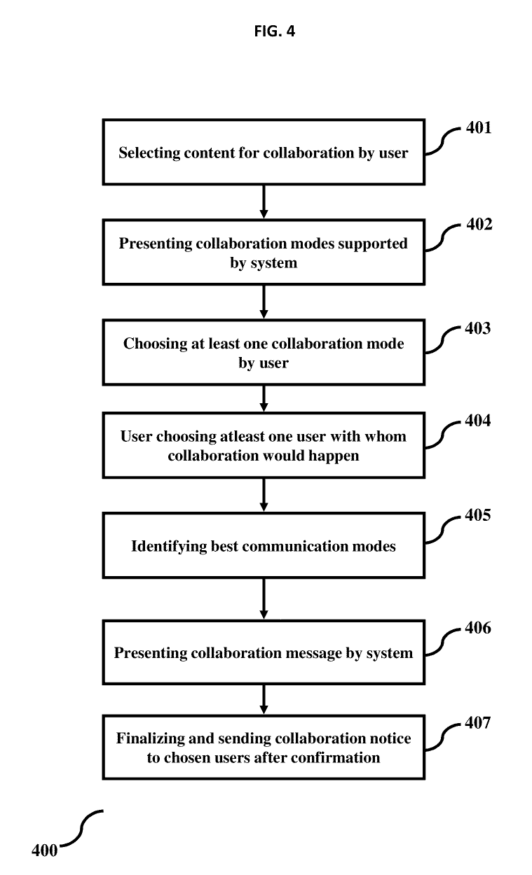

FIG. 4 is a flow diagram illustrating the process of creating and initiating a seamless collaboration and communication session, according to embodiments herein. A user selects (401) a content for collaboration using his user device 102. The content may be a document, a presentation, a video, an audio file, an image file or any content which may be capable of being edited by a user. The content selected is dependent on the capability of the underlying user device 102 to associate and launch an appropriate application for the content that integrates with the instant application. Further, the user device 102 used for selecting content may be phones, Personal Digital Assistants (PDAs), tablets, laptops, computers or any other device that supports a standard operating system like Android, Microsoft Windows, Linux, Symbian, iOS and so on and that can connect to at least one communication network 101.

Once the user selects the document for collaboration, the system presents (402) the user with possible collaboration modes using the user device 102. The system may facilitate collaboration using applications such as AceProject, Collaba and so on. Further, the collaboration application provided to the user may be set up on the cloud or may be hosted on corresponding server. In one embodiment, the user may be able to select a collaboration method from the provided list. The possible collaboration mode depends on the modes that are capable of being supported by the user device of the user. For example, some user devices may be supporting AceProject and some other user devices may be supporting Collaba and not AceProject. The user may also be able to select review related collaboration options. For example, if a WORD document is selected, then review related collaboration options may be presented, which may comprise of the application permitted to open the document (For example, MICROSOFT WORD, OPENOFFICE WRITER and so on). If media content is selected, then a set of options like collaborative viewing with chat session may be presented to the user. The user chooses (403) at least one mode for collaboration using his/her user device 102. The user may select mode for collaboration using a suitable user interface present in the user device. The user device may be a keypad, touch screen and so on which depends on the type of user device.

Further, the user selects (404) at least one user with whom collaboration would happen, using his/her user device. The users may be selected from a list of contacts (a phonebook, a contact list, a friends list and so on). In some embodiments, the contacts that the user frequently interacts with may be presented at the top of the list or with prominence so that the user can choose them easily. In some other embodiments, user may also be allowed to save groups of users for easy selection of a group of users for collaboration. In another embodiment, the user may be able to add/remove contacts to/from the contact list. The system may also provide means automatically adding contacts to the user's contact list from the user's social networking and email accounts. For example, the system may request access to the user profiles in social networking websites and email accounts and may automatically add the contacts present in these accounts to user's account list. The system may also provide means for grouping multiple contact information of a single user under a single name. In various embodiments, the system may present different groups of users to collaborate with, along with regular contact list. The user may also enter their respective contact details manually. The selected contact details will reflect the mode, in which the users want to communicate.

Further the system identifies (405) at least one best communication mode for the user to communicate with the selected users. In a preferred embodiment, the system may identify best communication modes to communicate with each user in the selected list, by analyzing augmented ubiquity information of each user. Further, the augmented ubiquity information of a user is formed by obtaining and processing various user parameters such as location of user, status of user, communication preference set by the user and so on related to each user. In another embodiment, the system may provide means for the user to manually select a communication medium if the augmented ubiquity data is not available. In this case, the user may select a communication medium from the list available communication mediums. Further, the user may select a communication medium that is supported by the user device. For example, the user device may be supporting audio call but the same device may not be supporting a video call. In this case, the user may select audio call from the list of communications as a preferred communication medium. Further, the communication mode selected by the system may be at least one of online chat, an audio call (over the internet or a phone network (cellular/PSTN)), a video call (using the internet, a phone network (cellular/PSTN), a combination of internet and phone networks), using desktop share and call or real time review. The user may also select a combination of modes, depending on the convenience of the other users involved in the collaboration, using his/her user device 102.

Further, the system presents (406) the user a User Interface (UI) depicting the collaboration message, where the collaboration message comprises of list of the selected users, the respective communication modes, pre-set time information which depicts time of start of user interaction and any other related information. In some embodiments, the user may pre-define a template for the collaboration message, which may be for future use. The system automatically attaches the content selected along with any other necessary information to initiate the collaboration session. The UI enables the user to initiate and/or send the collaboration message to the other users, along with an approved time slot for the collaboration. The users may also edit details on the collaboration page.

Further, the user finalizes and sends (407) the collaboration message to the other users, after confirming the details on the collaboration page. The collaboration message may be in the form of a text message, audio message or any such suitable form. Further the collaboration message may reach the user device through a suitable channel. For example, a voice message may reach the user device through a voice channel. Further, the user who receives the collaboration message may join the collaboration and communication session at the time specified in the collaboration message. Further, the user may be able to access the content being collaborated using a suitable application. In one embodiment, the collaboration and communication session may be manually terminated by the user who initiates the session or by any other user who has got admin access. In another embodiment, the collaboration and communication session may be terminated automatically by the system at a pre-set time. The various actions in method 400 may be performed in the order presented, in a different order or simultaneously. Further, in some embodiments, some actions listed in FIG. 4 may be omitted.

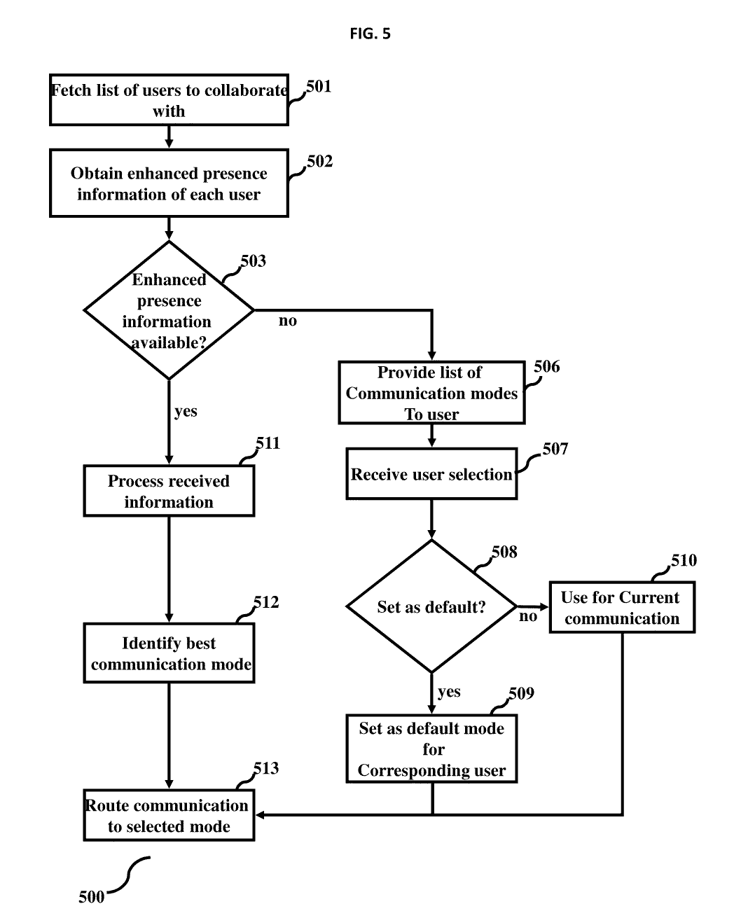

FIG. 5 is a flow diagram illustrating the process of integrated collaboration and communication through augmented ubiquity implementation, as disclosed in the embodiments herein. The system initially fetches (501) the list of users with whom the collaboration would happen. Further, the system checks (503) augmented ubiquity information related to each selected user. The augmented ubiquity information related to each user may be obtained by collecting information about various parameters associated with each user present and by separately processing the obtained information. The various parameters that are collected to form presence information of a user may comprise status of the user, location information of the user, communication preference set by the user and so on. The user status may be any of away, busy, available and so on and is set by the user in corresponding communication application. For example, the user may set his/her status as “available” in GTALK. Further the location information of the user may be obtained by the system using suitable means such as Global positioning System (GPS), Location Based search (LBS) and so on. The location information of the user may indicate the location of the user at any particular instant of time. Further, the communication preference of a user may indicate the communication mode the user prefers to use for communication. For example, a user may be available on different communication medium such as mobile, VOIP and so on. But if the user prefers to have the communication via VOIP, he/she may set VOIP as a preferred communication mode.

In a preferred embodiment, if the augmented ubiquity information is available, the system fetches the augmented ubiquity information related to each user who is a part of the user interaction. Further, the system processes (511) the fetched presence information and identifies (512) the best communication mode corresponding to each user present in the selected list.

An example embodiment of how the system identifies best communication mode for each user based on Augmented ubiquity information is shown below.

| | | Status/ | | | |
|---|---|---|---|---|---|
| Channels | User | Result | Location | Preference | Available |
| Business # | User 1 | Available | Work | Mobile First | VOIP, |
| | | Mobile # | | | Mobile # |
| Business # | User 2 | Available | In-transit | VOIP, | VOIP, |
| | | Mobile # | | Mobile | Mobile # |
| Business # | User 3 | Busy/Voice | work | VOIP, | VOIP, |
| | | Mail | | Mobile | Mobile # |

In this table, consider case of user 1 for example. User 1's status is set as “available on mobile”. Further the system, using a suitable means such as LBS and/or GPS, identifies that the location of user 1 is his/her workplace. Further the system identifies the preference of user over the communication medium to be used to contact him/her. For user 1, the preference is given as mobile first. So for user 1, the system selects VOIP over Mobile as the communication medium.

Further, the system routes (513) the communication to the identified best communication mode. For example, if the selected communication mode is VOIP over mobile, the system routes the communication to the selected communication mode and initiates a voice communication over the user's mobile device.

In another embodiment, if the augmented ubiquity information with respect to any user is not available, the system provides means for manually selecting a communication mode to the user to communicate. In a preferred embodiment, the system may provide (506) a list of available communication modes to the user. The list of available communication modes may comprise list of users with corresponding statuses in various communication channels such as GTALK, SKYPE and so on. The list may contain users and corresponding communication modes arranged in an order. The list may show the most frequently used modes at the top of the list. Further the user can select at least one communication mode from the list of available communication modes. The user may also select combination of multiple communication modes based upon requirement. Further, the system receives (507) the user selection and checks (508) if the user wishes to set the preferred communication medium as a default option for that user. The default option may give privilege to the system to automatically select that particular communication medium for any future communication with that user. If the user wishes to set that communication medium as default for future communications, the system sets (509) the communication mode as default for that user. If the user does not wish to set the communication mode as default, the system uses (510) the selected communication mode for current use only.

Further the system routes (513) the communication mode to selected communication mode. For example, if the selected communication mode is VOIP over mobile, the system routes the communication to the selected communication mode and initiates a voice communication over the user's mobile device. The various actions in method 500 may be performed in the order presented, in a different order or simultaneously. Further, in some embodiments, some actions listed in FIG. 5 may be omitted.

### Example Embodiment

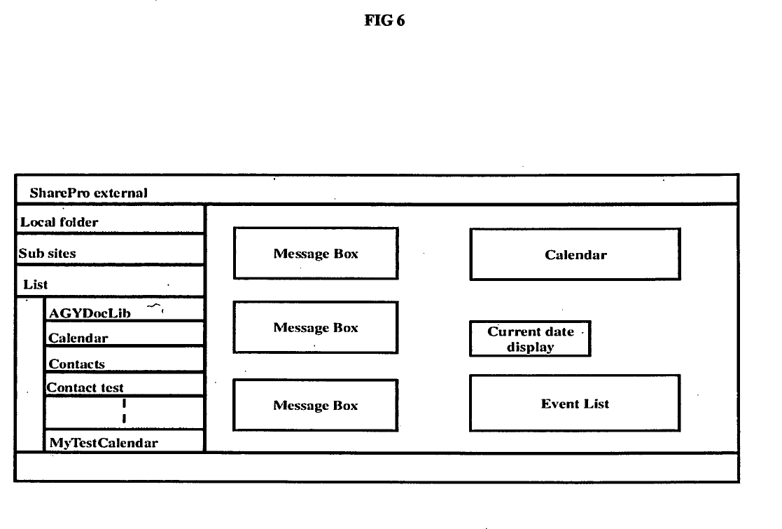

FIG. 6 shows a screenshot of an exemplary implementation, where the instant application integrates with Microsoft SharePoint to provide collaboration support, according to an example embodiment.

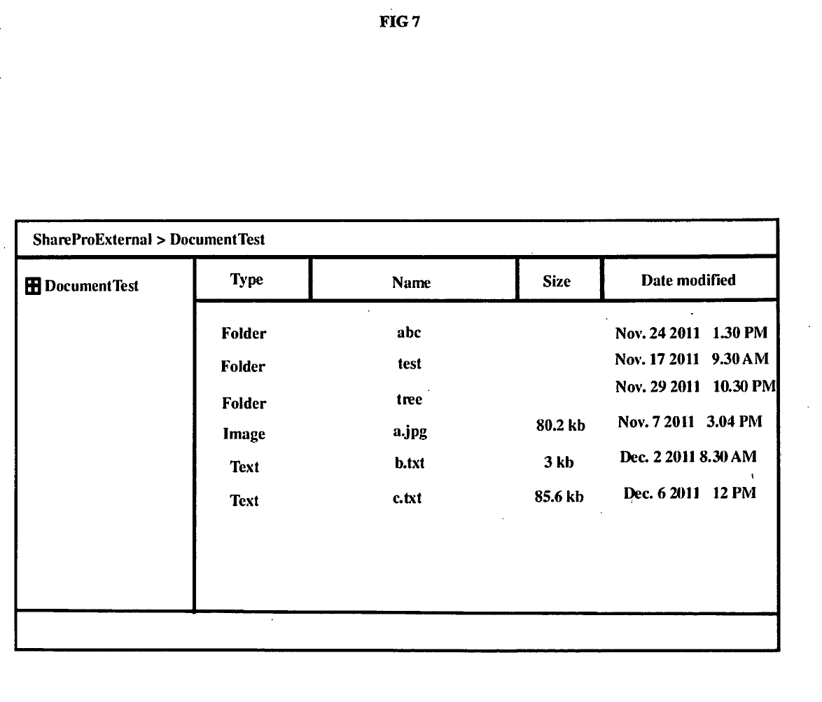

FIGS. 7, 8, 9 and 10 show screenshots depicting a user selecting content for collaboration, the time of review (instant review as depicted herein), selecting the communication mode and the user selecting users from the users present online for instant review, according to an example embodiment.

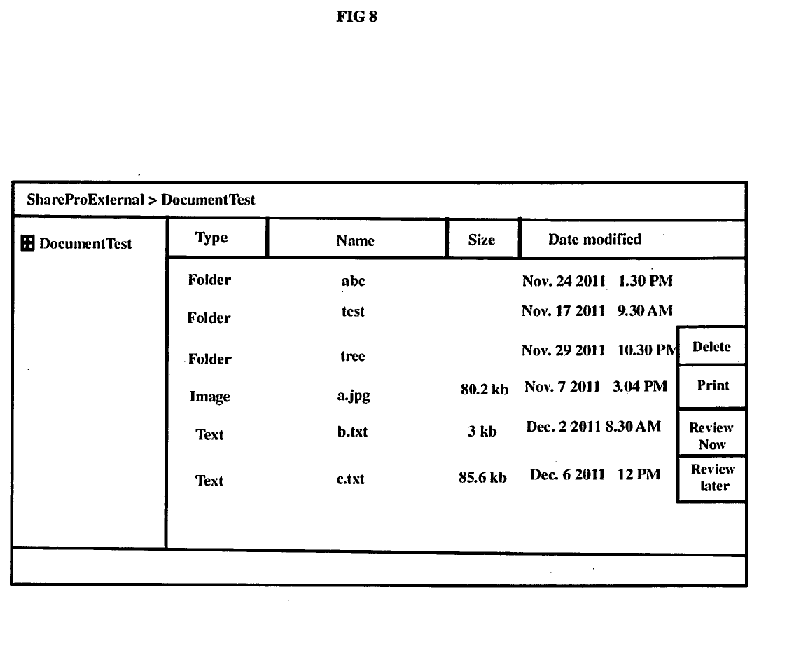

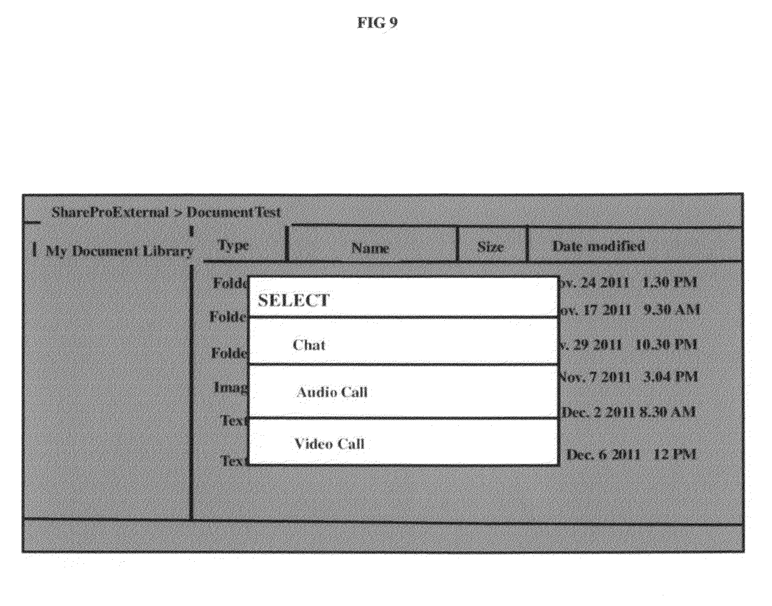

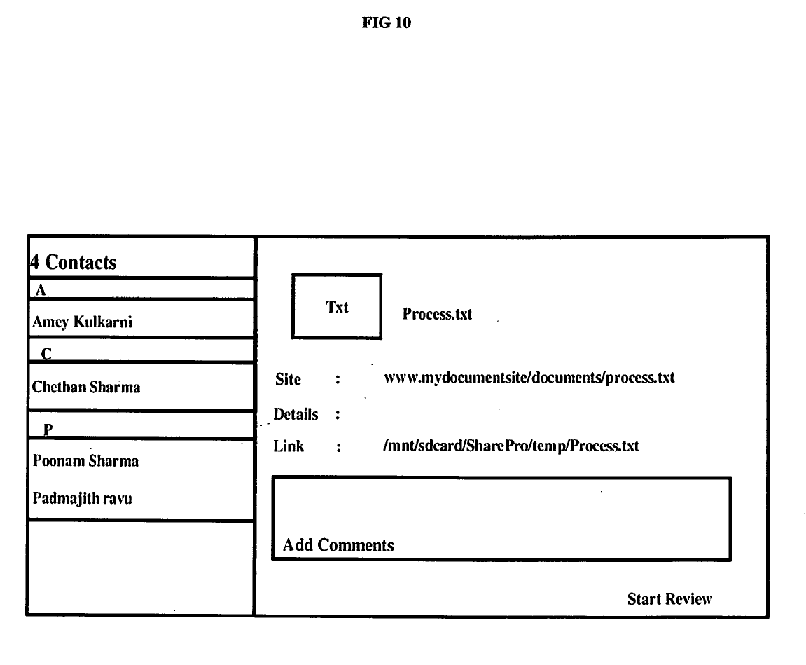

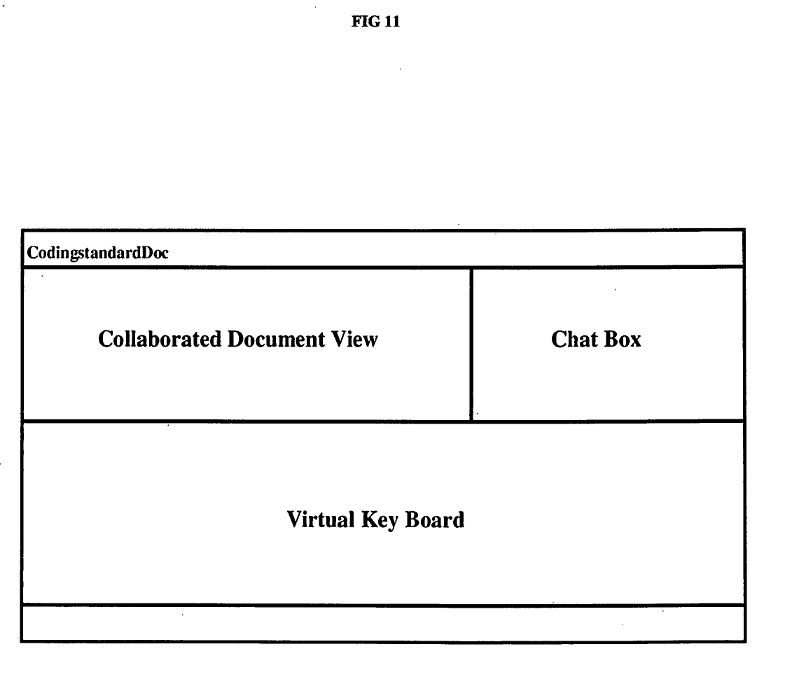

In this exemplary implementation, the MICROSOFT SHAREPOINT presents a list of document libraries (as shown in FIG. 6) for a user choose and navigate. User selects a library of documents, and the list of documents from the selected document library is presented to the user (as shown in FIG. 7). User further chooses a document to collaborate. At this point, the application 210 invokes a list of collaboration options for the user to choose from as shown in FIG. 8. Based on the collaboration option chosen by the user, user may be presented with appropriate communication options, as shown in FIG. 9. Upon the choosing the communication option, user is presented with users to be added to the collaboration session, as shown in FIG. 10. Upon choosing to initiate the collaboration session, the user is taken into the collaboration session initiated, as shown in FIG. 11. In the collaboration session, user is presented with document being viewed and collaborated on and an associated chat window, as the user selected to review a document during the collaboration session and selected chat as a mode of communication.

Embodiments described herein makes collaboration and communication seamless combining the different application used in the process of collaboration in a seamless manner.

The embodiments disclosed herein can be implemented through at least one software program running on at least one hardware device and performing network management functions to control the network elements. The network elements shown in FIGS. 1 and 2 include blocks which can be at least one of a hardware device, or a combination of hardware device and software module(s).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for creating a seamless communication and collaboration on a user device in a communication network, said method comprising
selecting a content for collaboration by said user using said user device;
selecting a method for collaboration by said user using said user device;
selecting a plurality of participating users to be added to a collaboration and communication session using said user device; and
identifying best communication modes for each of said plurality of participating users by said user device.

2. The method as claimed in claim 1, wherein said selecting of said collaboration mode further comprises:
presenting a list of available collaboration modes to said user by said user device; and
receiving a selection of a collaboration mode from one of said list of available collaboration modes from said user by said user device.

3. The method as claimed in claim 1, wherein identifying said best communication mode for a participating user among said plurality of participating users comprises of obtaining and analyzing augmented ubiquity data of said participating user based on present availability of said participating user.

4. The method as claimed in claim 1, wherein identification of said best communication mode is done automatically by said user device.

5. The method as claimed in claim 4, wherein identification of said best communication mode automatically by said user device further comprises
fetching augmented ubiquity information of said users; and
analyzing said fetched augmented ubiquity information.

6. The method as claimed in claim 1, wherein identification of said best communication mode is done manually by said user.

7. The method as claimed in claim 6, wherein identification of said best communication mode manually by said user further comprises
receiving a list of users and communication modes from said user device; and
selecting best communication mode from said list.

8. The method as claimed in claim 1, wherein said communication and collaboration session with each of said plurality of participating users is initiated based on said selected method for collaboration and identified best communication modes.

9. The method as claimed in claim 8, wherein initiation of said communication and collaboration session with said plurality of participants further comprises
receiving collaboration request from said user;
routing communication to said identified best communication modes; and
sending a collaboration request to said plurality of participants.

10. The method as claimed in claim 9, wherein initiation of said communication and collaboration session with said plurality of participants is at same time.

11. The method as claimed in claim 9, wherein said initiation of said communication and collaboration session with said plurality of participants at a later time.

12. A method for creating and initiating a communication and collaboration session in a communication network, said method further comprising:
selecting a content for collaboration by said user using said user device;
selecting a method for collaboration by said user using said user device;
selecting a plurality of participating users to be added to a collaboration and communication session using said user device;
identifying best communication modes for each of said plurality of participating users by said user device; and
initiating said communication and collaboration session with each of said plurality of participating users based on said selected method for collaboration and identified best communication modes.

13. The method as claimed in claim 12, wherein selecting of said collaboration mode further comprises
presenting a list of available collaboration modes to said user by said user device; and
receiving a selection of a collaboration mode from one of said list of available collaboration modes from said user by said user device.

14. The method as claimed in claim 12, wherein identification of said best communication mode for said participating user among said plurality of participating users comprises obtaining and analyzing augmented ubiquity data of said participating user based on present availability of said participating user.

15. The method as claimed in claim 12, wherein identification of said best communication mode is done automatically by said user device.

16. The method as claimed in claim 15, wherein identification of said best communication mode automatically by said user device further comprises
fetching augmented ubiquity information of said users; and
analyzing said fetched augmented ubiquity information.

17. The method as claimed in claim 15, wherein identification of said best communication mode is done manually by said user.

18. The method as claimed in claim 17, wherein identification of said best communication mode manually by said user further comprises
receiving a list of users and communication modes from said user device; and
selecting best communication mode from said list.

19. The method as claimed in claim 12, wherein initiation of said communication and collaboration session with said plurality of participants further comprises
receiving collaboration request from said user;
routing communication to said identified best communication modes; and
sending a collaboration request to said plurality of participants.

20. The method as claimed in claim 12, wherein initiation of said communication and collaboration session with said plurality of participants is at same time.

21. The method as claimed in claim 12, wherein said initiation of said communication and collaboration session with said plurality of participants is at later time.

22. A method for initiating a communication and collaboration session using a single interface in a communication network, said method further comprising
selecting a content for collaboration by said user using said single interface;
selecting a method for collaboration by said user using said single interface;
selecting a plurality of participating users to be added to a collaboration and communication session using said single interface;
identifying best communication modes for each of said plurality of participating users by said single interface; and
initiating said communication and collaboration session with each of said plurality of participating users based on said selected method for collaboration and identified best communication modes using said single interface.

23. A user device for creating a seamless communication and collaboration session using a single application interface, said application hosted on said user device in a communication network, said application configured for
presenting a means for selecting a content for collaboration by said user;
presenting a means for selecting a method for collaboration by said user;
presenting a means for selecting a plurality of participating users to be added to a collaboration and communication session; and
identifying best communication modes for each of said plurality of participating users.

24. The user device as claimed in claim 23, wherein said application is configured for presenting a means for selecting said collaboration mode by
presenting a list of available collaboration modes to said user; and
receiving a selection of a collaboration mode from one of said list of available collaboration modes from said user.

25. The user device as claimed in claim 23, wherein said application is configured for identifying best communication mode for a participating user among said plurality of participating users by obtaining and analyzing augmented ubiquity data of said participating user based on present availability of said participating user.

26. The user device as claimed in claim 23, wherein said application is configured for identifying said best communication mode automatically using said user device.

27. The user device as claimed in claim 26, wherein said application is configured for identifying said best communication mode automatically by
fetching augmented ubiquity information of said users; and
analyzing said fetched augmented ubiquity information.

28. The user device as claimed in claim 23, wherein said application is configured for providing means for manually identifying said best communication mode to said user.

29. The user device as claimed in claim 28, wherein said application is configured for identifying said best communication mode manually by
receiving a list of users and communication modes; and
selecting best communication mode from said list.

30. The user device as claimed in claim 23, wherein said application is configured for initiating said communication and collaboration session with each of said plurality of participating users based on said selected method for collaboration and identified best communication modes.

31. The user device as claimed in claim 30, wherein said application is configured for initiating said communication and collaboration session with said plurality of participants
receiving collaboration request from said user;
routing communication to said identified best communication modes; and
sending a collaboration request to said plurality of participants.

32. The user device as claimed in claim 31, wherein said application is configured for initiating said communication and collaboration session with said plurality of participants at same time.

33. The user device as claimed in claim 31, wherein said application is configured for initiating said communication and collaboration session with said plurality of participants at a later time.
